(19) United States
(12) Patent Application Publication
(10) Pub. No.: US 2013/0275248 A1
(43) Pub. Date: Oct. 17, 2013

(54) PAYMENT SYSTEM FOR SERVICES AND GOODS

(71) Applicant: Tomofumi Miyashige, Shizuoka-shi (JP)

(72) Inventor: Tomofumi Miyashige, Shizuoka-shi (JP)

(73) Assignee: NALTEC, INC., Shizuoka (JP)

(21) Appl. No.: 13/880,411

(22) PCT Filed: Oct. 20, 2011
(86) PCT No.: PCT/JP2011/005883

§ 371 Date: Jun. 18, 2013

(30) Foreign Application Priority Data
Oct. 20, 2010 (JP) 2010-235533

(51) Int. Cl. G06Q 20/20

(52) U.S. Cl. CPC G06Q 20/209
USPC 705/24

(57) ABSTRACT

A POS register includes a printer that prints receipt information including a content of a payment by a user onto a sheet; a touch panel that displays a button for selecting whether printing of the receipt information is necessary; an input unit that enables the user to input a transmission destination address to which the receipt information is to be transmitted via a computer network; and an output unit that transmits the receipt information to the transmission destination address if the transmission destination address has been inputted when it is selected whether printing of the receipt information is necessary using the button.

### TECHNICAL FIELD

The present invention relates to a system, such as a POS (Point Of Sale), that enables customers to make payments (or settlements).

### BACKGROUND ART

Japanese Laid-Open Patent Publication No. H10-55384 discloses a technology that facilitates the generation of household accounts and the verification of the purchasing of goods while making receipts unnecessary. To do so, the publication discloses a construction including a shop terminal which generates receipt information based on inputted purchase information for goods, identifies the customer in question and uploads the receipt information to such customer, a customer-specific receipt file storing receipt information uploaded from the shop terminal on a customer-by-customer basis, and a customer terminal capable of accessing the customer-specific receipt file and referring to receipt information for each customer.

Japanese Laid-Open Patent Publication No. 2001-291167 discloses a POS register that outputs a sales receipt when an operator or a customer has selected the outputting of a receipt during the registration of a sale. To do so, the publication discloses that the POS register includes: an operator-side receipt output button and a customer-side receipt output button in an input circuit for receipt output buttons; a trade completion button for completing a trade; a receipt output processing means that converts the operator-side receipt output button and the customer-side receipt output button; a receipt output flag that stores an output of the receipt output processing means and illuminates the operator-side receipt output button and the customer-side receipt output button; a sale registration processing means that refers to the receipt output flag at an end of operation of a trade data input means and edits the trade data into a receipt format if the receipt output flag is on; and a receipt print output means outputting a receipt to an internal printer.

### SUMMARY OF THE INVENTION

Some customers require a printed out receipt, some customers do not require a receipt, some customers want to have receipt information uploaded and managed on a desired server or at a desired address on a network, and some customers do not require such management. Also, systems that allow payments to be made for services and/or goods have a variety of forms, such as POS registers used in convenience stores and department stores, cash registers used in restaurants, gasoline POS used at gas stations, and payment systems used in vending machines. Various payment methods also exist, such as payment with cash, payment by credit card, payment using a contactless IC card, and payment with a prepaid card, with many card companies in operation.

In this way, there is a great variety of payment methods, conditions, and customer demands for a system (or “payment system” or “store terminal”) that carries out payments. Management by collecting receipt information at a predetermined address on a network is also known for a household accounts management system and the like. However, it is not easy to upload and manage receipt information for payments made according to various settlement methods (payment methods) at a predetermined address desired by the user. As one example, although it is possible to set an uploading address in the personal information at a credit card company, since data is provided after payment by the credit card company has been completed, it is difficult to manage household accounts in real time. Also, although it may be possible to upload data at a store affiliated with a specified card company, in many cases such service cannot be used outside affiliated stores.

It is also possible for a mobile terminal to receive receipt information sent from a register or to scan a receipt so that data can be collected at a desired address via an individual's mobile terminal. However, the customer may not always have the time to manually transfer receipt information or to scan receipts. It is also wasteful to print out receipts simply in order to have the receipt information scanned.

One aspect of the present invention is a system that enables a customer to pay for services and/or goods. Such system enables a customer to pay for at least one of services and products and includes: a printer that prints receipt information including a content of a payment by the customer onto a sheet; a touch panel that displays a first icon for selecting whether printing of the receipt information is necessary (required or not); an input unit that enables the customer to input a transmission destination address (destination address) to which the receipt information is to be transmitted via a computer network; and an output unit transmitting the receipt information to the transmission destination address if the transmission destination address has been inputted when it is selected whether printing of the receipt information is necessary using the first icon displayed on the touch panel. The first icon may be an image such as a button, a mark, or a symbol, or may be a character display.

In this system, timing is provided to allow the customer to select whether to have the receipt information printed by the printer, and the outputting of unneeded receipts is avoided. In addition, the timing where the user selects whether a receipt is necessary is used as timing where it is possible for the customer to input a transmission destination address for the receipt information. Accordingly, it is possible for the customer to input the desired address fundamentally with no dependence on the type of payment method and/or payment system, to have receipt information uploaded to the desired address and to rapidly and collectively manage the state of the payments.

The input unit should preferably include: a communication unit that acquires the transmission destination address of the customer via contactless communication with a mobile terminal or an IC card of the customer; or an optical unit that reads data including the transmission destination address of the customer displayed on a mobile terminal of the customer. The customer is capable of setting desired address information in advance in the mobile terminal or the IC card. The customer is then capable of setting the desired address by merely placing the mobile terminal or IC card near the communication unit before selecting whether a receipt is necessary. Also, by converting the desired address to a code, such as a two-dimensional code, that can be read by an optical unit, displaying the code on the mobile terminal, and having the code read by the optical unit, it is possible for the customer to set the desired address by merely placing the mobile terminal near the optical unit before selecting whether a receipt is necessary.

On the other hand, a customer for whom uploading of the receipt information is unnecessary is capable of selecting whether to receive a receipt by selecting whether a receipt is necessary without inputting a desired address. Accordingly, the system is capable of coping with the desires of various customers, i.e., customers who do not need a receipt or receipt information, customers who do not need a receipt and only need receipt information, customers who only need a receipt, and customers who need both a receipt and receipt information, by effectively having customers select whether a receipt is necessary or not.

In this system, the printer that prints the receipt information (receipt) should preferably include the output unit that transmits receipt information to a transmission destination address. Since the printer acquires the receipt information for printing a receipt, it is easy to construct the system by outputting such receipt information to a computer network such as the Internet.

In addition, it is desirable to further include a function (first functional unit) that displays a message, which prompts input of the transmission destination address, together with the first icon, such as a button, on the touch panel. The customer will look closely at the touch panel to select whether a receipt is necessary. Accordingly, by displaying that it is possible to input a transmission destination address, it is possible to reduce incidences where a customer for whom uploading of receipt information is necessary forgets to input the destination address.

It is also effective for the system to include a function (second functional unit) that displays information, which includes at least one of a commercial and promotion, together with the button on the touch panel. The customer will look closely at the touch panel to select whether a receipt is necessary or not. Accordingly, by displaying on the touch panel, it is possible to provide store information and the like to the customer more reliably and effectively.

Another aspect of the present invention is a control method for a system that enables a customer to pay for services and/or goods. Such system includes: a printer that prints receipt information including a content of a payment by the customer onto a sheet; a touch panel; a control unit that controls input/output of the touch panel; an input unit that enables the customer to input a transmission destination address to which the receipt information is to be transmitted via a computer network; and an output unit transmitting the receipt information to the transmission destination address. In addition, the control method includes the following steps.

The control unit displaying a first icon for selecting whether printing of the receipt information is necessary (required or not) on the touch panel.

Transmitting the receipt information to the transmission destination address if the transmission destination address has been inputted when it is selected whether printing of the receipt information is necessary using the first icon.

Displaying the first icon should preferably include the control unit displaying a message, which prompts input of the transmission destination address, together with the first icon on the touch panel. Also, displaying the first icon should preferably include the control unit displaying information, which includes at least one of a commercial and promotion, together with the first icon on the touch panel.

Also, the control method includes printing the receipt information using the printer only when a selection that printing of the receipt information is necessary has been made using a button displayed on the touch panel. It is therefore possible to avoid the unnecessary printing out of receipts for customers who do not need a receipt.

### BRIEF DESCRIPTION OF THE DRAWINGS

FIG. 1 is a diagram showing an overview of a system including a POS register.

FIG. 2 is a block diagram of a receipt printer.

FIG. 3 is a diagram showing an example display on a touch panel of the receipt printer.

FIG. 4 is a flowchart showing the operation of the POS register and the receipt printer.

### DETAIL DESCRIPTION

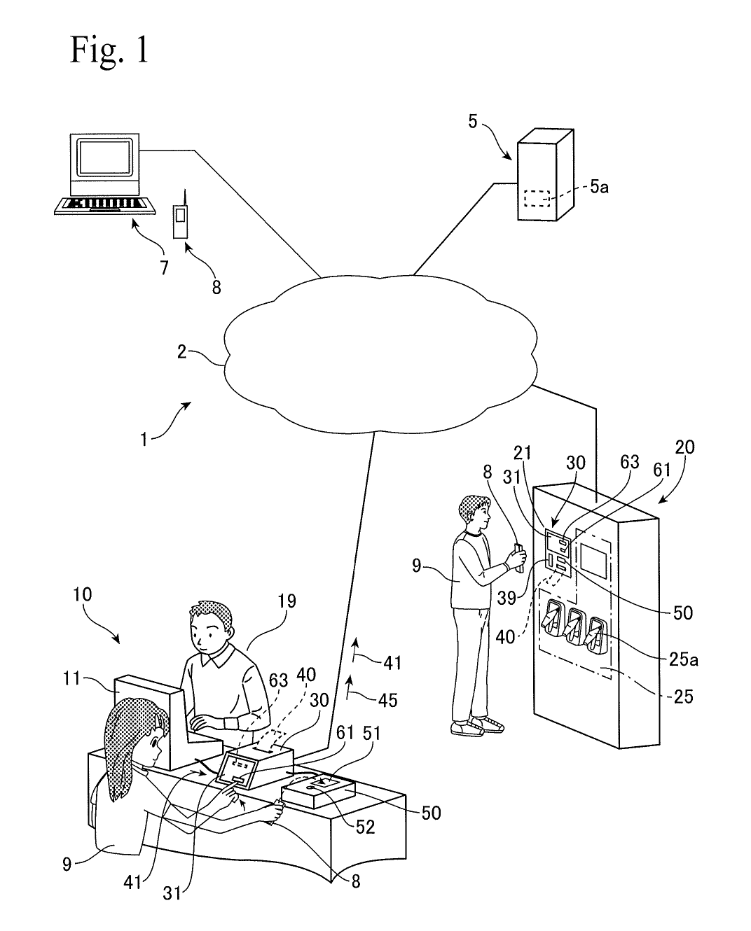

FIG. 1 shows an example of a system that stores receipt information on a server via the Internet. This system 1 includes POS registers (or “store terminals” or “store systems”) 10 and 20 connected to the Internet 2, a server 5 that stores receipt information for each user (customer), and a user terminal or terminals, for example a personal computer 7 and/or a mobile terminal (mobile phone) 8 capable of using the receipt information stored in the server 5 via the Internet 2.

The POS register 10 is one example of a system that enables a customer (user) 9 to make payments for services and/or goods at a store such as a convenience store. The POS register 10 includes a POS terminal 11, a receipt printer 30 that prints out receipt information obtained from the POS terminal 11, and an input unit 50 that receives a data input from the user 9. The receipt printer 30 includes a display (hereinafter “touch panel”) 31 that is a display integrally incorporated into a front wall or a front surface of the receipt printer 30 and has a touch panel function.

The POS terminal 11 includes an interface that enables store staff 19 to input information on a service and/or goods purchased by the user 9. The POS terminal 11 is connected to a POS system inside or outside the store via a LAN and/or the Internet and generates information that enables the user 9 to make a payment (settlement). Together with or instead of an input by store staff 19, the POS terminal 11 may be an apparatus or a system that inputs payment information when the user 9 takes goods from a shelf and/or automatically inputs payment information for goods when the goods pass the POS register 10. The POS terminal 11 may be a standalone payment apparatus for a store, such as a register.

The receipt printer 30 is equipped with a function for acquiring receipt information 41 including payment information from the POS terminal 11 and outputting (i.e., printing out) a receipt 40 where such receipt information 41 is printed on a sheet. A button-like symbol (icon, design, graphic) 61 that selects whether a receipt 40 is required is displayed on a touch panel 31 on the front surface of the printer 30. Together with this, a message 63 indicating that it is possible to input a transmission destination address (destination address) for transmitting the receipt information 41 is displayed on the touch panel 31. The user 9 is capable of inputting an address showing a registration region 5a on the server 5, for example a URL, via the input unit 50 before selecting whether a receipt 40 is required or not. The URL (transmission destination address) of the desired registration region 5a on the server 5 inputted by the user 9 is an address on the Internet where the user 9 wishes to transmit, store, or accumulate the receipt information 41. The receipt printer 30 is equipped with a function as an output unit that transmits the receipt information 41 via the Internet 2 to a desired destination address.

The input unit 50 includes a communication unit 51 and an optical unit 52. The communication unit 51 is capable of acquiring information via wireless communication. The communication unit 51 communicates with an IC card or an IC card function incorporated in the mobile terminal (mobile phone or PDA) 8 to acquire desired data, in this example, a transmission destination address 45 of the receipt information 41. The optical unit 52 is a scanner, camera, or the like and is capable of acquiring data via an image. The optical unit 52 reads an image outputted on a screen of the mobile terminal 8, for example, a two-dimensional code and acquires the transmission destination address 45 of the receipt information 41.

The user 9 carries the mobile terminal 8 in which the transmission destination address 45 is set so as to be readable by the communication unit 51 and/or the optical unit 52. The user 9 is capable of inputting the transmission destination address 45 by placing the mobile terminal 8 near the input unit 50. An input system or input program that transmits the destination address 45 from the mobile terminal 8 or has the destination address 45 displayed on the mobile terminal 8 so as to be readable by the input unit 50 is provided to the user 9 by an appropriate means. Typically, the input system or input program is provided from a provider or operator of household accounts software together with household accounts software that is used on the personal computer 7 and/or the mobile terminal 8 of the user 9. The transmission destination address 45 may be an address of a server 5 managed by the provider or operator of household accounts software or may be an address of the server 5 managed by the user 9.

When the user 9 touches the icon 61 displayed on the touch panel 31 on the front surface of the receipt printer 30 to select outputting of a receipt 40, the receipt printer 30 prints the receipt 40. Together with this, if the transmission destination address 45 has been inputted, the receipt printer 30 transmits the receipt information 41 to the transmission destination address 45. The receipt printer 30 may be connected to a computer network, such as the Internet 2, directly (which here includes a wired or wireless connection) or may be connected via the POS terminal 11 to the computer network. If a transmission destination address 45 has not been inputted, the receipt information 41 is not transmitted. If it has been selected via the touch panel 31 that a receipt 40 is unnecessary, a receipt 40 is not printed. Note that even if the user 9 has selected that printing of a receipt 40 is unnecessary, if a transmission destination address 45 has been inputted, the receipt information 41 is transmitted to the transmission destination address 45.

The POS register 20 is an automatic vending machine for goods or services and here a so-called “gasoline POS” or “gas-POS” that is installed at a self-service gas station is shown as an example. The gasoline POS 20 includes a goods selecting unit 25 that enables the user 9 to select a desired type of gasoline and pumps such gasoline into a vehicle and a register unit 21 that carries out payment (settlement). The register unit 21 is composed of the receipt printer 30 that prints the receipt information acquired from the goods selecting unit 25. The receipt printer 30 includes an incorporated printer mechanism, the touch panel 31, a card insertion opening 39 for making a card settlement, and the input unit 50 for acquiring the transmission destination address 45.

At this POS register 20, before goods are selected by the goods selecting unit 25, cards that can be used for settlement are indicated (displayed) on the touch panel 31 of the receipt printer 30 that constructs or functions as the register unit 21 so that the user will insert (attach) a card to the card insertion opening 39. Once the card information is approved, operation of the goods selecting unit 25 becomes possible and the user 9 selects the desired gasoline nozzle 25a and fills the car. Once filling has ended, an icon, for example, a button 61 for selecting whether a receipt 40 is necessary is displayed on the touch panel 31 of the receipt printer 30 of the register unit 21. At the same time, the message 63 showing that the inputting of a transmission destination address to which the receipt information 41 is to be transmitted is possible is displayed on the touch panel 31. If the user 9 wishes to transmit receipt information 41 to the desired registration region 5a on the server 5, before selecting whether a receipt 40 is necessary, the destination address 45 showing the registration region 5a on the server 5 is inputted using the input unit 50.

The subsequent processing is the same for the POS register 20 as the POS register 10. If the user 9 selects the outputting of a receipt 40 using the button 61 displayed on the touch panel 31 of the receipt printer 30, the receipt printer 30 prints out a receipt 40. Together with this, if a transmission destination address 45 has been inputted, the receipt printer 30 transmits the receipt information 41 via a computer network such as the Internet 2 to such destination address 45. If a transmission destination address 45 has not been inputted, the receipt information 41 is not transmitted, and if a receipt 40 is selected as unnecessary via the touch panel 31, a receipt 40 is not printed out.

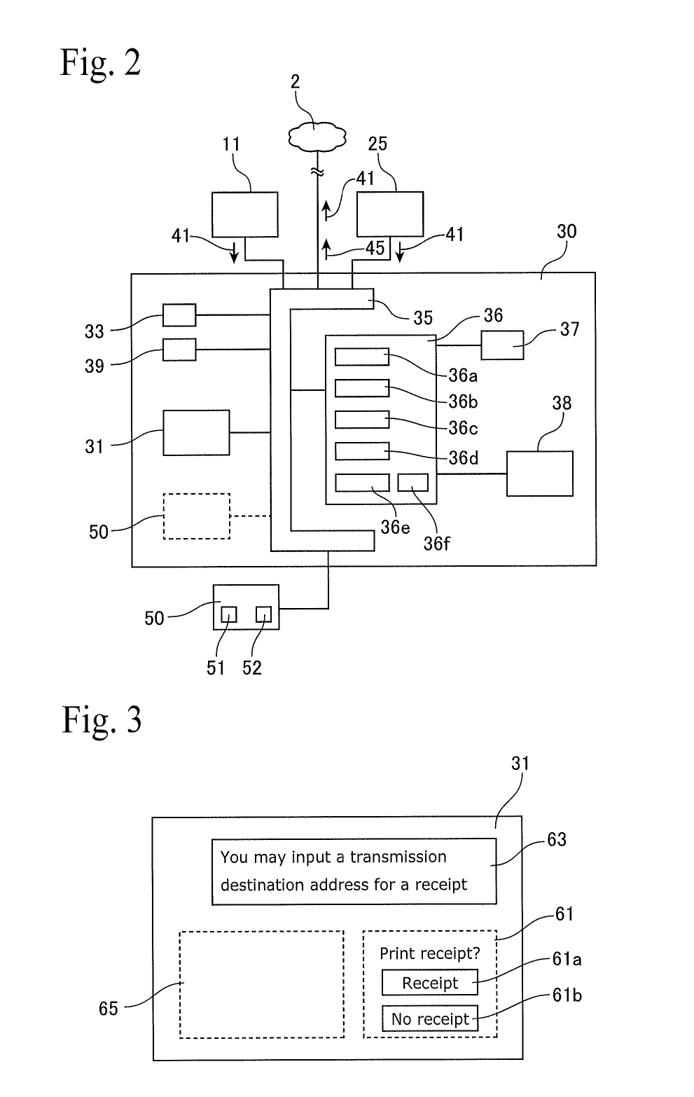

FIG. 2 shows the overall configuration of one example of the receipt printer 30 by way of a block diagram. The receipt printer 30 includes an interface group 35 that carries out inputting and outputting of data according to various protocols, a CPU (processor) 36 that is a control unit of the receipt printer 30, a memory 37 storing programs and data, and a print mechanism 38 that prints a receipt. A typical example of the print mechanism 38 is a thermal printer that prints information onto thermal paper in the form of a roll. The print mechanism 38 may be an ink jet printer or another type of printer.

Various types of input/output unit that are incorporated in and/or externally attached to the receipt printer 30 are connected to the interface group 35. The touch panel 31 equipped with a display function, the card interface (with insertion opening) 39 used for settlement, a human sensor 33, and the input unit 50 equipped with the communication unit 51 and the optical unit 52 can be given as examples of input/output units. Such input/output units may be incorporated in the receipt printer 30 or may be externally attached.

The POS terminal 11 and/or the goods selecting unit 25 are also connected by an appropriate communication means, for example USB, a computer network, or the like to the interface group 35. Accordingly, the receipt printer 30 is capable of acquiring the receipt information 41 from the POS terminal 11 and/or the goods selecting unit 25. It is also possible to connect the Internet 2 and/or an Intranet to the interface group 35 and to transmit the receipt information 41 to the destination address 45. This means that the interface group 35 functions as an output unit within the receipt printer 30. If the receipt printer 30 is not directly connected to the Internet 2, the receipt information 41 is capable of transmitting the receipt information 41 to the transmission destination address 45 via the POS terminal 11 and/or the goods selecting unit 25 connected to the interface group 35.

The CPU 36 that is the control unit realizes a number of functions by loading programs stored in the memory 37. First, the CPU 36 realizes a number of functions 36a to 36c that control the touch panel 31. An icon display function (functional unit) 36a acquires the receipt information 41 and displays the button 61 for selecting whether the printing of the receipt information 41 is required on the touch panel 31. The message display function (first functional unit) 36b displays a message 63 that prompts input of a transmission destination address 45 on the touch panel 31 together with the button 61. The commercial display function (second functional unit) 36c displays information (a message and/or images (which includes still images and moving images)) including a commercial and/or promotion on the touch panel 31 together with the button 61.

One example of the display on the touch panel 31 is shown in FIG. 3. The icon display function 36a displays a “receipt” button 61a and a “no receipt” button 61b. By touching one of the buttons, the user 9 selects whether printing out of a receipt is necessary or not (required or not).

The message display function 36b displays a message 63 “You may input a transmission destination address for a receipt” at the same time as the button 61a and the button 61b. As viewing the touch panel 31 for selecting whether outputting of a receipt is required, the user 9 recognizes that it is possible to input a transmission destination address 45 for the receipt (receipt information) 41. Accordingly, it is possible for a user 9 who wishes to transmit the receipt information 41 to the server 5 to input a destination address 45 into the input unit 50 without forgetting. The message 63 is not limited to such and may have a variety of forms, such as an indication for inputting the transmission destination address 45 before the selection of the button 61a or 61b, flashing a display unit, such as LEDs, provided on the input unit 50, or an explanation of the method of inputting the transmission destination address 45 into the input unit 50.

The commercial display function 36c displays a promotion/commercial message 65 at the same time as the buttons 61a and 61b on the touch panel 31. The promotion/commercial message 65 is a commercial relating to a feature product of the day, event information for the day or a coming day, or goods the user has bought, and as one example is promotion or a commercial for another company with the same or similar goods. Since the user 9 will view the touch panel 31 to operate the button 61a or 61b, the promotion/commercial message 65 can be effectively delivered or informed to the user 9.

As shown in FIG. 2, the functions realized by the CPU 36 of the receipt printer 30 further include a function (functional unit) 36d that transmits the receipt information 41 to the transmission destination address 45. If a transmission destination address 45 could be acquired when the button 61a or 62b that select whether printing the receipt information 41 is needed or not (i.e., required or not), the transmission function 36d transmits the receipt information 41 to the transmission destination address 45. With the receipt printer 30, it is possible for the user 9 to input the transmission destination address 45 from the mobile terminal 8 via communication or an image. Accordingly, even if the transmission destination address 45 of the user 9 is not set in advance at a card company or another settlement system, it is possible to transmit the receipt information 41 to the destination address 45 desired by the user and to collect the receipt information 41 at such transmission destination address 45. Also, even if the payment method is any of cash, a credit card, an IC card, or the like, it is possible to accumulate the receipt information 41 at the transmission destination address 45 regardless of the type of payment system, such as a POS register or a check counter.

In addition, it is possible to collect the receipt information 41 at the predetermined transmission destination address 45 even if settlements are not made via a credit company and to view such receipt information 41 via the Internet 2 on the user terminal 7 or the mobile terminal 8. Accordingly, it is possible to summary the receipt information 41 in almost real time and have such receipt information 41 reflected in household accounts software or the like.

Also, the functions realized by the CPU 36 of the receipt printer 30 include a function (functional unit) 36e that prints a receipt 40. Such print function 36e prints a receipt 40 according to an operation of the button 61a or 61b for selecting whether printing of the receipt information 41 is possible. If the “no receipt” button 61b is selected, a receipt 40 is not outputted. This means that it is possible to suppress the resource cost for users 9 who do not require a receipt 40.

In addition the functions realized by the CPU 36 of the receipt printer 30 include a function (functional unit) 36f that discards the receipt information 41. The discarding function 36f automatically discards the receipt information 41 if a predetermined period has passed without the button 61a or 61b for selecting whether printing of the receipt information 41 is necessary being operated and a person is not detected in front of the touch panel 31 by the human sensor 33. It is also possible to discard the receipt information 41 if a predetermined period has passed or if a person is not detected by the human sensor 33. If the user 9 leaves without operating the buttons 61a and 61b, a receipt 40 is not outputted and the receipt information 41 is automatically discarded. It is also possible to discard the receipt information 41 according to an operation from the POS terminal 11 and/or an inputting of receipt information 41 for the next user 9.

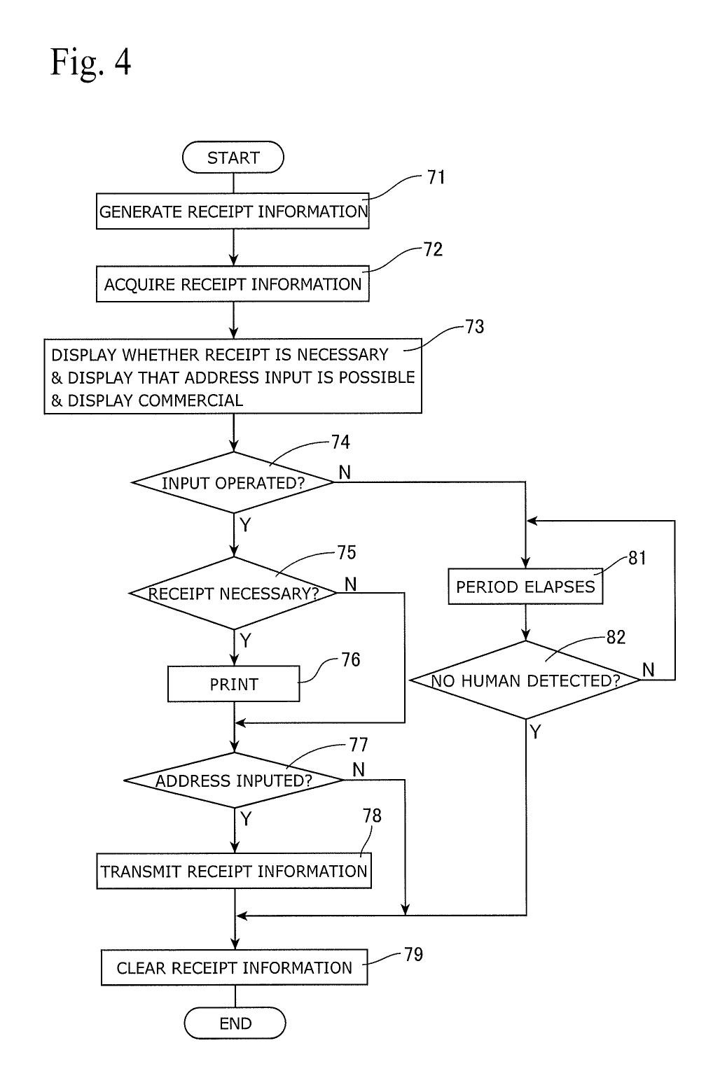

FIG. 4 shows an overview of processing by the POS register 10 by way of a flowchart. In step 71, payment information is gathered at the POS terminal 11 and the receipt information 41 is generated. In step 72, the receipt printer 30 acquires the receipt information 41. Once the receipt printer 30 has acquired the receipt information 41, in step 73 the buttons 6a and 61b showing whether a receipt is necessary or not, the message 63 urging the user to input the transmission destination address 45, and the promotion/commercial message 65 are displayed by the display functions 36a to 36c. In step 74, a button is operated and if the “receipt” button 61a has been selected in step 75, in step 76 the print function 36e prints a receipt 40. If the “no receipt” button 61b has been selected in step 75, the print function 36e does not print a receipt 40.

If, in step 77, a transmission destination address 45 has been inputted, in step 78 the transmission function 36d transmits the receipt information 41 to the transmission destination address 45. Once the transmission has been completed, in step 79 the discarding function 36f discards the receipt information 41. Also, if a predetermined period has passed in step 81 without the buttons 61a and 61b showing whether a receipt is necessary being operated and it has been confirmed in step 82 by the human sensor 33 that a person is not present in front of the touch panel 31, in step 79 the receipt information 41 is discarded.

If, after step 73, a transmission destination address 45 has been inputted, a message showing that the transmission destination address 45 has been inputted may be displayed in addition to the message 63 or instead of the message 63 on the display panel/touch panel 31 shown in FIG. 3. One example of a message showing that the transmission destination address 45 has been inputted is a reception confirmation message such as “Transmission destination address has been received” or the inputted transmission destination address 45 may be displayed. It is also possible to set a content, such as a handle name, to be displayed in place of the transmission destination address 45 in the mobile terminal 8, IC card, or the like that stores the transmission destination address 45 and to display such content in place of the transmission destination address 45 itself. Although it is possible to transmit the receipt information 41 at this stage, the selecting of a button (icon) 61 in step 75 is used as a step of confirming the inputted transmission destination address 45.

The main flow of processing is the same in the POS register 20. In this way, on the POS registers 10 and 20, the buttons 61a and 61b are displayed on the touch panel 31, timing is provided to allow the user 9 to select whether to have the receipt information (receipt) 41 printed by the receipt printer 30, and the outputting of unneeded receipts 40 is avoided. In addition, the POS registers 10 and 20 use the timing where the user 9 selects whether a receipt 40 is necessary as timing where it is possible for the user 9 to input the transmission destination address 45 for the receipt information 41. Accordingly, it is possible for the user 9 to input the desired transmission destination address 45 regardless of the type of payment method and/or payment system. This means that it is possible for the user 9 to have the receipt information 41 uploaded to the desired destination address 45 and to rapidly manage the state of the user's payments using the receipt information 41 that has been collected in a desired area (the registration region 5a) of the server 5.

Note that although the receipt printer 30 that incorporates the touch panel 31 has been described above as an example, the touch panel 31 may be separately provided. The receipt printer 30 and the touch panel 31 may be incorporated in the POS terminal 11. In addition, although a gasoline POS is shown as an automatic vending POS system (register) 20, the goods that are automatically vended are not limited to gasoline and may be beverages, magazines, or the like. Also, aside from information relating to the user 9's payment, the receipt information 41 may include information that the store or the like wishes to provide to the user 9, such as points information and commercial and/or promotion information. By transmitting receipt information 41 including points information and the like to the predetermined transmission destination address 45, it is possible to collectively manage not only information relating to payments but also information relating to points.

1. A system that enables a customer to pay for at least one of services and goods, comprising:
a printer that prints receipt information including a content of a payment by the customer onto a sheet;
a touch panel that displays a first icon for having the customer select each time whether printing of the receipt information is necessary;
an input unit that enables the customer to input each time a transmission destination address to which the receipt information is to be transmitted via a computer network; and
an output unit that transmits the receipt information to the transmission destination address if the transmission destination address has been inputted when it is selected by the customer whether printing of the receipt information is necessary using the first icon and does not transmit the receipt information if the transmission destination address has not been inputted.

2. The system according to claim 1, further comprising a first functional unit that displays a message that prompts the customer to input the transmission destination address, together with the first icon on the touch panel.

3. The system according to claim 2, further comprising a second functional unit that displays information that includes at least one of a commercial and promotion, together with the first icon on the touch panel.

4. The system according to claim 1, wherein the input unit includes at least one of:
a communication unit that acquires the transmission destination address of the customer via contactless communication with a mobile terminal or an IC card of the customer; and
an optical unit that reads data including the transmission destination address of the customer displayed on a mobile terminal of the customer.

5. The system according to claim 1, wherein the printer includes the output unit.

6. A control method for a system that enables a customer to pay for at least one of services and goods, wherein the system includes:
a printer that prints receipt information including a content of a payment by the customer onto a sheet;
a touch panel;
a control unit that controls input/output of the touch panel;
an input unit that enables the customer to input a transmission destination address to which the receipt information is transmitted via a computer network; and
an output unit transmitting the receipt information to the transmission destination address,
and the control method comprises:
the control unit displaying a first icon for having the customer select each time whether printing of the receipt information is necessary on the touch panel;
displaying a message that prompts input of the transmission destination address, together with the first icon on the touch panel and having the customer input the transmission destination address each time; and
transmitting the receipt information to the transmission destination address if the transmission destination address has been inputted when it is selected by the customer whether printing of the receipt information is necessary using the first icon and not transmitting the receipt information if the transmission destination address has not been inputted.

7. (canceled)

8. The control method according to claim 6, wherein the displaying includes the control unit displaying information that includes at least one of a commercial and promotion, together with the first icon on the touch panel.

9. The control method according to claim 6, further comprising the printer printing the receipt information only when a selection that printing of the receipt information is necessary has been made using the first icon.

10. The control method according to claim 6, wherein the input unit includes at least one of a communication unit that carries out contactless communication with a mobile terminal or an IC card of the customer and an optical unit that optically reads data, and
the control method further comprises acquiring the transmission destination address of the customer through contactless communication between the communication unit and the mobile terminal or the IC card of the customer or by reading data displayed on the mobile terminal of the customer using the optical unit.

11. The system according to claim 4, further comprising a functional unit operable when the transmission destination address of the customer has been acquired by the input unit, to display a display indicating that the transmission destination address has been acquired in place of the transmission destination address itself.

12. The system according to claim 1, further comprising a functional unit operable when no selection of whether printing of the receipt information is necessary has been made using the first icon and either a specified period has elapsed or a person is not detected in front of the touch panel by a human sensor, to discard the receipt information.

13. The control method according to claim 10, further comprising displaying, when the transmission destination address of the customer has been acquired by the input unit, a display indicating that the transmission destination address has been acquired in place of the transmission destination address itself.

14. The control method according to claim 6, further comprising discarding the receipt information when no selection of whether printing of the receipt information is necessary has been made using the first icon and either a specified period has elapsed or a person is not detected in front of the touch panel by a human sensor.
